(19) United States
(12) Patent Application Publication
(10) Pub. No.: US 2002/0017198 A1
(43) Pub. Date: Feb. 14, 2002

(54) METHOD AND APPARATUS FOR DEEP FRYING A FOOD PRODUCT

(76) Inventors: Susan M. Gauthier, Mission Viejo, CA (US); Todd D. Evans, Corona, CA (US); Lesley K. Swartout, San Marcos, CA (US); Micah Tsern, Tustin, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/431,018

(22) Filed: Nov. 1, 1999

(51) Int. Cl. A23L 1/00; A47J 37/12; A23P 1/00; A47J 43/18

(52) U.S. Cl. 99/330; 99/403; 99/426; 99/427; 99/410; 426/438

(57) ABSTRACT

A food product can be shaped into a U-shape and deep fried using a deep fry apparatus. The deep fry apparatus includes a basket and a mold. The basket has a plurality of curved receptacles for receiving the curved food product. The mold includes a plurality of inserts which each correspond to and fit within a receptacle of the basket. The mold supports the inserts within the receptacle to maintain a desired clearance between each insert and the corresponding receptacle to prevent crushing of the product. The mold also has sufficient weight to inhibit movement of the food product and insert during the deep frying process. The mold thus maintains the food product in a curved position during deep frying.

### RELATED CASE

This application is a continuation-in-part of pending U.S. application Ser. No. ______, filed Oct. 29, 1999.

### BACKGROUND OF THE INVENTION

1. Field of the Invention

The present invention relates generally to a method and apparatus for deep frying a food product, and in particular to a method and apparatus for deep frying flat bread in a curved shape.

2. Description of the Related Art

Various food products can be deep fried to make the product crispy. In addition, deep frying adds flavor to the product. One example of a deep fried product is a crispy taco shell made by deep frying a tortilla in oil. Other crispy shells, such as an edible basket for a taco salad, can be made by deep frying a tortilla in hot oil.

Various shaped deep fry baskets can be used to form the tortilla into a desired shape and to suspend the tortilla in oil during deep frying. For instance, a taco shell basket can be used to simultaneously deep fry a number of tortillas into crispy taco shells. The basket has a plurality of compartments, each having a generally V-shape.

A separate wire insert is positioned within each compartment of the basket to help form the inner shape of the taco shell. Because tortillas are thin and are not susceptible to being crushed, the wire insert can rest directly on top of the tortilla.

### SUMMARY OF THE INVENTION

The present invention relates to an apparatus and method for deep-frying a food product, such as flat bread which is susceptible to being crushed due to air pockets within the bread, into a product having a curved shape. While certain prior art devices can be used to deep fry tortillas into various shapes, these same devices are not suitable for deep frying other food products, such as those containing air pockets or large voids, those having a greater thickness, and those having a different texture, into a curved product.

In accordance with one aspect of the present invention, an apparatus for deep frying a food product includes a basket and a mold. The basket has a plurality of receptacles connected together, each having a generally U-shaped cross-section and an open end to receive the food product. The mold has a plurality of insert sections each having a generally U-shaped cross-section and being sized to fit at least partially within a receptacle of the basket. The insert sections are connected together and oriented such that at least some of the plurality of insert sections correspond with at least some of the plurality of receptacles when the basket and mold are placed together.

In accordance with another aspect of the present invention, a deep fry apparatus for deep frying a food product includes a basket having at least one receptacle with two generally opposing walls and a curved section, and means for holding the food product in a curved shape within the receptacle without compressing the food product within the receptacle.

In accordance with a further aspect of the present invention, a method is disclosed for deep frying flat bread. The method involves placing the flat bread in a basket having at least one receptacle with a curved shape, maintaining the flat bread in a curved shape without compressing the flat bread, and deep frying the flat bread. To maintain the flat bread in a curved shape, a curved insert is placed at least partially within the receptacle.

### BRIEF DESCRIPTION OF THE DRAWINGS

The invention will now be described with reference to the appended drawings which depict embodiments of aspects and features of the invention. The illustrated embodiments, however, are intended to only illustrate and not to limit the invention. The drawings contain the following figures:

FIG. 1 is a perspective view of a deep fry apparatus in accordance with the present invention.

FIG. 2 is an exploded perspective view of the basket and mold of the deep fry apparatus of FIG. 1.

FIG. 3 is a side elevational view of the deep fry apparatus of FIG. 1.

FIG. 4 is a front elevational view of the deep fry apparatus of FIG. 1.

FIG. 5 is a front elevational view of the deep fry apparatus of FIG. 3, the apparatus being tilted at an angle α.

FIG. 6 depicts a flowchart diagramming the acts of deep frying flat bread in accordance with a preferred mode of the present invention.

### DETAILED DESCRIPTION OF THE PREFERRED EMBODIMENT

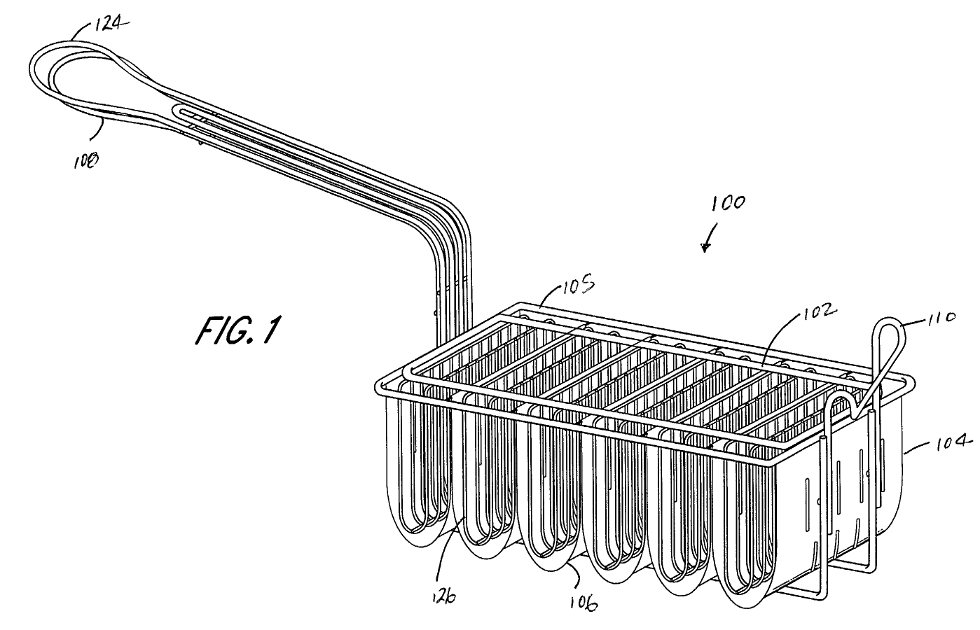

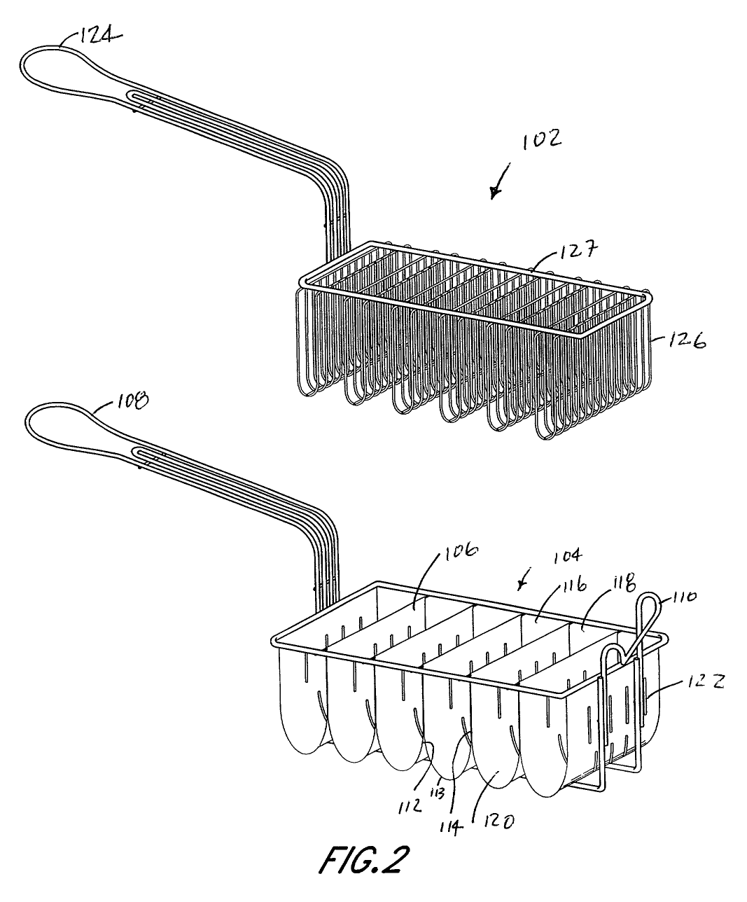

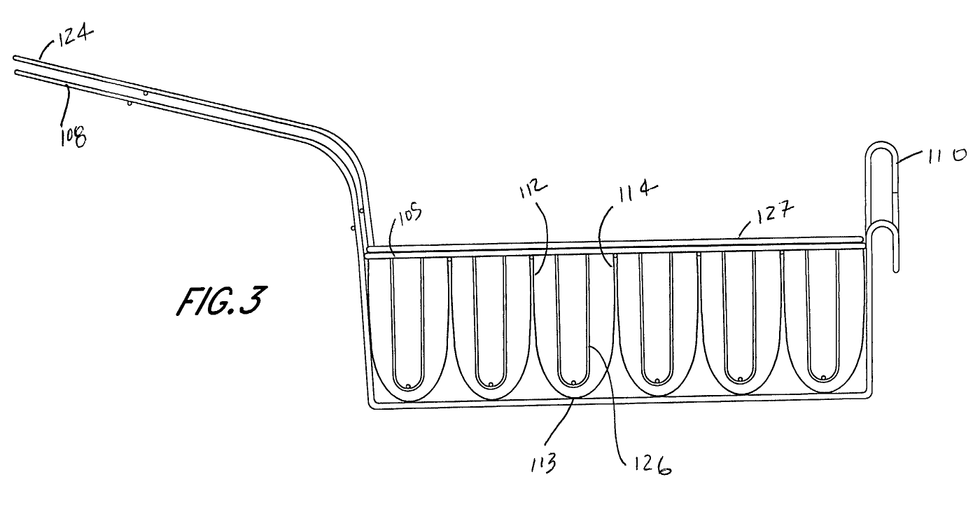

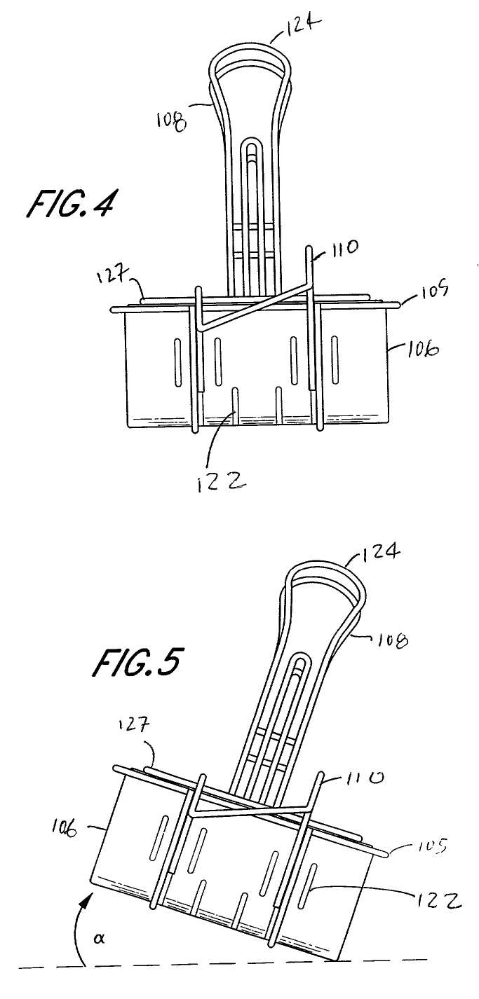

FIGS. 1 and 2 illustrate an apparatus for deep frying a food product. The following description describes the deep fry apparatus for use in deep frying flat bread; however, those skilled in the art will appreciate that the apparatus can be used with a variety of food products of a similar character in a similar manner.

The deep fry apparatus 100 illustrated in FIGS. 1 and 2 includes a mold 102 and a basket 104. In FIG. 1, the mold 102 is positioned within the basket 104, and in FIG. 2, the mold 102 and basket 104 are shown separately.

The basket 104 has a plurality of receptacles 106, a handle 108 and a hook 110. In the illustrated embodiment, the basket 104 has a generally rectangular frame 105 to which each of the six receptacles 106 are attached. The basket 104 in illustrated embodiment includes six receptacles 106. In other embodiments, however, the basket can have any number of receptacles.

Each receptacle 106 of the basket 104 has a curved cross-section. In the illustrated embodiment, the receptacle 104 has a generally U-shaped cross-section. In other embodiments, the receptacle can be shaped like a “J” or other folded or curved shape. Each receptacle 106 preferably is formed from a single piece of sheet metal molded in a U-shape. The metal sheet defines opposing walls 112, 114 of the receptacle 106, which are generally parallel to one another, and a curved bottom section 113 joining the two walls 112, 114. The top 116 and sides 118, 120 of the receptacles 106 remain open, thereby allowing oil to flow into and through the receptacle 106. In addition, upon deep frying the flat bread can be removed from the basket 104 through the sides 118, 120 of the basket 120. The height of the receptacle 106 is thus greater than the height of the desired U-shape of the finished product.

A plurality of openings 122 or slots in the metal sheet also allow oil to flow through the walls 112, 114 of the receptacle 106. The openings 122 can be punched in the metal sheet. A combination of elongate slots and circular openings can be made in the walls 112, 114 of the receptacle 106 so that a sufficient amount of oil can flow through the receptacle 106 to achieve a desired fried texture and coloring of the flat bread upon deep frying.

The basket handle 108 extends from the basket 104, away from the receptacles 106. In the illustrated embodiment, the handle 108 is formed from a plurality of wires extending from the frame 105 of the basket 104 and shaped into an easy-to-grasp shape, such as the elongate shape shown in FIG. 2. In a preferred embodiment, the basket handle 108 is permanently attached to the basket. The handle 108 can also be detachably connected to the basket 104.

The hook 110 also extends from the basket 104 in a direction away from the receptacles 106. While in the illustrated embodiment, the hook 110 extends from the side of the basket opposite the handle 108, in other embodiments, the hook 110 can extend from any side of the basket 104. The hook 110 is shaped to position the basket 104 at an angle to allow oil to drain from the basket 104 after the flat bread is deep fried. For instance, the basket 104 can be hung from a bracket or other device to tilt the basket at an angle to allow for drainage of oil. By positioning the basket 104 at an angle, oil can drain from one of the sides 118, 120 of the receptacles 106. In addition, oil can also drain through the openings 116 in the receptacles 106 when the basket is in any position. In a preferred embodiment, the hook 110 is shaped so that when the basket is hung from the bracket, the bottom of the basket is tilted from a generally horizontal position preferably at an angle α, which is preferably between 22 degrees and 90 degrees, and more preferably at an angle of about 25 degrees.

As illustrated in FIG. 2, the mold 102 has a handle 124, and at least one insert section 126. In the illustrated embodiment, the mold 102 includes six insert sections 126. As with the basket 104, in other embodiments, the mold 102 can have any number of insert sections. The insert sections 126 preferably are each attached to a generally rectangular wire frame 127. The mold handle 124, which extends from the frame 127, is similar in shape to the basket handle 108. In a preferred embodiment, the mold handle 124 is permanently attached to the mold 102, but it can also be detachably connected to the mold 102.

Each insert section 126 is shaped to have a generally curved or folded shape, such as a U-shape or a J-shape, and is sized to fit at least partially within a receptacle 106 of the basket 104. A single insert section 126 fits within a single receptacle 106 to hold the flat bread in place during deep frying. Thus, the shape of the insert sections 126 are similar to the shape of the receptacles 106. In the illustrated embodiment, each insert section 126 is formed from a plurality of generally U-shaped wires. The wire structure of the insert sections 126 allows oil to freely flow through the insert 126.

When the insert frame 127 is positioned on top the basket frame 105, each insert section 126 is positioned within a corresponding receptacle 106 of the basket. The bottom of the inserts 126 prevent the product from floating within the receptacle 106. By interconnecting the inserts 126, and providing the insert handle 124, the mold has a sufficient weight to hold the flat bread in place within the basket during deep frying.

The size of each receptacle 106 and each insert section 126 will depend on the size of the food product to be cooked in the apparatus 100. Preferably, the receptacle 106 and insert section 126 will be sized so that after the food product is placed within the receptacle 106, and the insert 126 is positioned within the receptacle, the food product is in close proximity to the both the receptacle 106 and the insert section 126. In one embodiment, there is about ⅛ inch to about 3/16 inch of space between each side of the flat bread and each opposing wall 112, 114 of the receptacle, as well as between the inner surface of the flat bread and the insert section 126. This allows a sufficient amount of oil to flow through the receptacle 104 and insert section 126 in contact with the flat bread. In addition, the clearance between the flat bread and the insert 126 prevents the flat bread from being crushed or compressed between the insert 126 and the receptacle 106. The flat bread is compressed when there is sufficient pressure on the bread to crush it or to collapse the air pockets, or when the insert and receptacle bear against both sides of the flat bread.

A method of deep frying a food product, such as flat bread, will now be described in connection with FIG. 6. One or more flat breads can be deep fried simultaneously in the deep fry apparatus 100 described above. The basket 104 can be filled with up to as many flat breads as there are receptacles 106. For example, in the illustrated embodiment, up to six flat breads can be deep fried at a time. Each flat bread is inserted into one receptacle 106 of the basket 104 (see operation block 130).

The bread is generally folded (but not creased) approximately in half in a direction generally perpendicular to the grain lines of the flat bread. That is, the bread is rolled over to make a generally symmetric U-shape. With reference to the grain lines which run in one direction through the flat bread, the flat bread is inserted within the receptacle 106 so that the grain lines run along one opposing wall to the other opposing wall, thus forming a U-shape with each grain line. Because flat bread tears or splits easier in a direction generally parallel to the grain lines, by positioning the flat bread in the above fashion, there is less likelihood that the bread will tear or split along the fold as it is positioned in the receptacle 106.

Flat bread generally has a top side and a bottom side. The bottom side of flat bread is slightly flatter than the top side due to the compression of the bread against the pan or rack during baking. Because the flat bread rises during baking, the top side often rises slightly unevenly or with a few bubbles, thereby causing the top side to have more bumps or texture than the bottom side of the bread. For a desired “bubbly” look to the deep-fried flat bread, the flat bread is inserted into the receptacle 106 so that the top side of the flat bread lies adjacent to the opposing walls 112, 114 of the receptacle 106. Thus, the top side of the flat bread forms the outer surface of the fried product. During deep frying, the unevenness of the top side of the flat bread is magnified, thereby creating a bubbly look to the outer surface of the flat bread.

In accordance with a preferred method, the flat bread is positioned generally symmetrically within the receptacle 106 so that the flat bread can slide through the open sides 118, 120 of the receptacle after it has been fried. In accordance with other methods of the present invention, the flat bread can be positioned within the receptacle 106 unevenly so as to form a J-shape or other curved shape. Thus, even with a U-shaped receptacle, various shaped fried flat breads, other than a U-shape, can be produced.

After the desired number of flat breads are positioned within the basket 104, the flat breads are maintained in a generally U-shaped or curved position and deep fried. One method of maintaining the U-shape of the flat bread is by placing the weighted insert sections 126 of the mold at least partially within the receptacles 106 (see operations block 132). The insert sections 126 thus hold the flat bread in place during deep frying, and prevent the bread from floating out of the basket 104. Because the mold 102 sits atop the basket, the bread is not crushed.

The deep fry apparatus 100 and flat bread are inserted into hot oil to deep fry the flat bread (see operation block 134). The amount of time that the bread is cooked in the oil will depend on the thickness of the bread and the desired “crispiness” or color of the finished product. For example, a flat bread having a diameter of approximately 6-6.75 inches and a thickness of approximately 0.1-0.3 inch is placed in hot oil for about 20-90 seconds.

The mold 102 can be made of a sufficient weight so that the mold 102 does not float in the oil, but rather maintains its position in close proximity to the flat bread. In the illustrated embodiment, the weight of the plurality of inserts 126 connected to the frame 125 is sufficient to maintain the mold 102 in position within the basket 104. In other embodiments, additional weights can be added to the mold to accomplish this effect.

An operator can also hold the mold 102 in position within the basket during deep frying (see operation block 136). For example, by holding the basket handle 108 and the mold handle 124 together, the basket 104 and the mold 102 can be maintained in close proximity during deep frying. Additionally or alternatively, the inserts 126 can be mechanically or positively coupled to the basket 104 to prevent unintentional movement of the bread during frying. Further, the basket 104 and mold 102 can be coupled together during deep frying, such as by a hook or latch (not shown).

After the flat bread is sufficiently cooked in oil, the deep fry apparatus 100 is removed from the oil (see operation block 138), such as by grasping handles 108, 124, and the oil is drained from the apparatus and bread (see operation block 140).

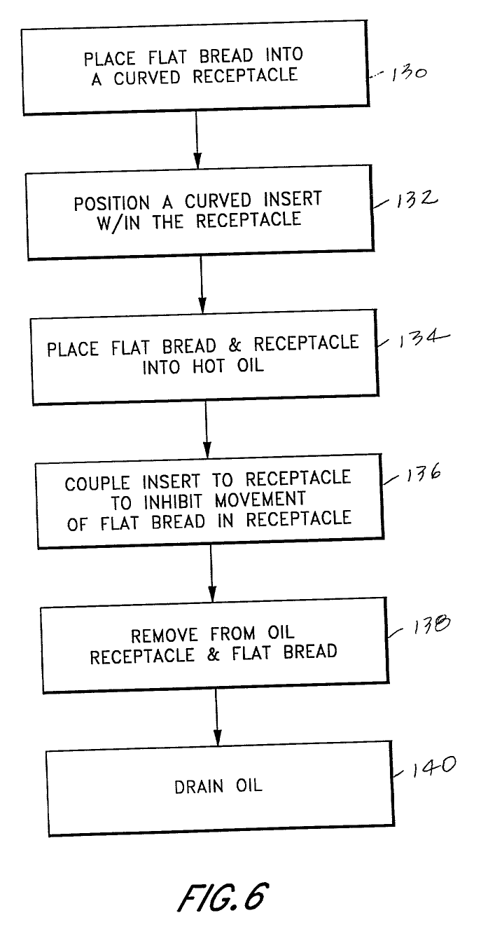

To facilitate drainage of the oil away from the flat bread, the apparatus 100 can be attached to a bracket by way of the angled hook 110. As illustrated in FIG. 5, when the angled hook 110 is positioned horizontally, the bottom of the basket is at an angle α. In a preferred embodiment, this angle is between 22 and 90 degrees, preferably at approximately 25 degrees. In this manner, oil is drained from the apparatus 100 through one of the open sides 118, 120 of the receptacles, as well as through the openings 122 of the receptacles.

While the present invention has been described with reference to deep frying flat bread, it is understood that the present invention can be equally applied to deep frying a other types of food products. Accordingly, the present invention is not limited by the recited preferred apparatus and method, but is intended to be defined solely by reference to the appended claims.

What is claimed is:

1. An apparatus for deep frying a food product, the apparatus comprising:
a basket having a plurality of receptacles, each receptacle having a generally U-shaped cross-section with an open end to receive the food product, the receptacles being connected together; and
a mold having a plurality of insert sections, each insert section having a generally U-shaped cross-section and being sized to fit at least partially within a receptacle of the basket, the insert sections being connected together and oriented such that at least some of the plurality of insert sections correspond with at least some of the plurality of receptacles when the basket and mold are placed together.

2. The apparatus of claim 1, wherein each receptacle has two generally opposing walls and a curved bottom section connecting the opposing walls.

3. The apparatus of claim 2, wherein the opposing walls are parallel to one another.

4. The apparatus of claim 2, wherein the distance between each opposing wall and the corresponding insert section is greater than the thickness of the food product.

5. The apparatus of claim 4, wherein the distance between each opposing wall and the insert section is at least ¼ inch greater than the thickness of the food product.

6. The apparatus of claim 1, wherein the mold is configured to sit on top of the basket to maintain a space between the insert sections and the corresponding receptacles, the space being at least as large as a thickness of the food product.

7. The apparatus of claim 1 additionally comprising an angled hook extending from the basket.

8. A deep fry apparatus for deep frying a food product, the apparatus comprising:
a basket with at least one receptacle having two generally opposing walls and a curved section; and
means for holding the food product in a curved shape within the receptacle without compressing the food product within the receptacle.

9. The deep fry apparatus of claim 8, wherein the means for holding the food product comprises a curved insert, the insert cooperating with the basket to assume a set position within the receptacle which is spaced from the curved section of the receptacle.

10. The deep fry apparatus of claim 9, wherein the insert additionally includes a handle extending from the insert.

11. The deep fry apparatus of claim 9, wherein the insert has a generally U-shaped cross-section.

12. The deep fry apparatus of claim 9, wherein the curved section of the basket is positioned from the curved insert at a distance approximately equal to a thickness of the food product.

13. The deep fry apparatus of claim 9, wherein each opposing wall of the receptacle is positioned away from the curved insert by a distance greater than a thickness of the food product.

14. The deep fry apparatus of claim 13, wherein the distance between each opposing wall of the receptacle and the curved insert is at least ¼ inch greater than the thickness of the food product.

15. A method of deep-frying flat bread involving:
placing the flat bread in a basket having at least one receptacle with a curved shape;
maintaining the flat bread in a curved shape without compressing the flat bread; and
deep frying the flat bread.

16. The method of claim 15, wherein maintaining the flat bread in a curved shape involves placing a curved insert at least partially within the receptacle.

17. The method of claim 16 additionally involving positioning a side of the flat bread in close proximity to the receptacle and an opposite side of the flat bread in close proximity to the insert.

18. The method of claim 17, wherein the insert is coupled to the basket.

19. The method of claim 17, wherein the insert is held in close proximity to the flat bread using a handle extending from the insert.

20. The method of claim 15, wherein deep frying the flat bread involves placing at least a portion of the basket and the flat bread in hot oil, and additionally involving removing the basket and flat bread from the oil and positioning the basket at an angle to drain the oil from the basket.

21. The method of claim 20, wherein the basket is positioned at an angle between 22 and 90 degrees.

22. The method of claim 21, wherein the basket is positioned at an angle of approximately 25 degrees.

23. The method of claim 15, wherein a plurality of flat breads are deep fried simultaneously, the method involving placing a plurality of flat breads within the basket, the basket having a plurality of U-shaped receptacles, each flat bread being placed in a separate receptacle, and placing a mold having a plurality of inserts within the basket such that one insert is positioned at least partially within each receptacle containing a flat bread.
